(19) United States
(12) Patent Application Publication
(10) Pub. No.: US 2018/0349950 A1
(43) Pub. Date: Dec. 6, 2018

(54) DETERMINING LONG-TERM VALUE TO A PUBLISHING USER FOR PRESENTING CONTENT TO USERS OF AN ONLINE SYSTEM

(71) Applicant: Facebook, Inc., Menlo Park, CA (US)

(72) Inventors: Jingxian Wu, Singapore (SG); Richard Morrisroe, Dublin (IE)

(21) Appl. No.: 15/610,337

(22) Filed: May 31, 2017

(51) Int. Cl. G06Q 30/02; G06Q 10/06

(52) U.S. Cl. CPC G06Q 30/0247; G06Q 30/0246; G06Q 30/0272; G06Q 10/067

(57) ABSTRACT

An online system estimates a long term value of various online system users to a publishing user who provides content to the online system for presentation to users. The publishing user may use the long term value when determining amounts of compensation to the online system for presenting content items from the publishing user. To estimate the long term value, the online system obtains retention data for a set of users describing user interaction with one or more objects during a time interval and determines a model describing user interaction with one or more objects over an additional time interval. From the model, the online system determines an average amount of time users interact with the one or more objects, which the online system uses along with an average revenue per daily active user to determine the long term value for the publishing user.

### BACKGROUND

This disclosure relates generally to presenting content to users of an online system, and more specifically to determining a value to a publishing user of presenting content associated with an object to users via the online system.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

A publishing user often includes a bid amount a sponsored content items that specifies a maximum amount of compensation the publishing user provides the online system in exchange for presenting the sponsored content item to users. However, when determining the bid amount for the sponsored content item, the publishing user has limited information about potential revenue to the publishing user from presentation of the sponsored content item. Because the publishing user specifies the bid amount when the sponsored, the publishing user is unable to accurately estimate revenue to the publishing user from presentation of the sponsored content item via the online system. This limited information may cause the publishing user to inefficiently allocate resources for presenting the sponsored content item resulting in the publishing user receiving a sub-optimal return from compensation provided to the online system for presenting the content item, which may discourage the publishing user from providing additional sponsored content to the online system.

### SUMMARY

A publishing user provides one or more content items to an online system to distribute information about objects, such as products or services, associated with the publishing user to online system users. Content items presented to users by the online system may encourage users to perform various interactions with objects associated with the publishing user, which may provide revenue or other benefits to the publishing user. For example, the publishing user provides content items to the online system associated with an application associated with the publishing user to encourage other online system users to install the application or to purchase items for use via the application. This allows the publishing user to leverage information maintained by the online system to disseminate information about one or more objects associated with the publishing user to a broader audience.

The publishing user often compensates the online system for presenting the one or more content items. For example, the online system receives compensation from the publishing user for each presentation of a content item from the publishing user to an online system user. As another example, the online system receives compensation from the publishing user each time an online system user to whom a content item from the publishing user was presented by the online system performs a specific action (e.g., selects a link included in the content item). The publishing user may include a bid amount in each content item that specifies a maximum amount of compensation the publishing user provides the online system when a content item is presented by the online system or when an online system user presented with the content item performed a particular action. Accounting for revenue the publishing user receives from online system users who were presented with one or more content items from the publishing user by the online system allows the publishing user to more effectively specify bid amounts for various content items provided to the online system. However, the publishing user has limited information regarding actions by online system users to whom content items were presented outside of a relatively short time interval after presentation of a content item, limiting accuracy with which the publishing user may specify bid amounts for content items.

To allow the publishing user to better estimate revenue from online system users over longer time intervals, the online system obtains information describing interaction by each of a set of users of the online system during a time interval with one or more objects for which the online system maintains information. In some embodiments, each user of the set has one or more specific characteristics. For example, each user of the set is a user to whom a content item provided to the online system by the publishing user was presented within a particular time interval. The content item in the preceding example may be a content item having one or more specific characteristics. For example, the content item is associated with a specific type of object or is associated with a user having one or more specific characteristics, one or more of which may be specified by the publishing user. The obtained information may identify specific actions performed by each user of the set during the time interval; in some embodiments, the publishing user may identify the specific actions. For example, the obtained information identifies one or more interactions by users with an application having one or more characteristics.

In some embodiments, the online system obtains the information describing interactions by the set of users with the one or more objects during the time interval from the publishing user. For example, the publishing user maintains information describing interactions by users with an application or with other content provided by the publishing user during the time interval and provides the information to the online system. Alternatively, the online system identifies users who interacted with one or more objects during the time interval based on information stored by the online system identifying actions performed by users. For each of the identified users, the online system obtains interactions by the identified users with one or more objects during the time interval. In some embodiments, the publishing user identifies a target object to the online system, so the online system identifies users who performed an action associated with the target object, or with objects having at least a threshold amount of characteristics matching characteristics of the target object, during the time interval.

From the obtained information describing interaction by each of the set of users with the one or more objects during the time interval, the online system determines a model describing interaction by online system users with the target object during an additional time interval, which is longer than the time interval for which the information was obtained. In various embodiments, the online system analyzes interactions by users with the one or more objects at different times within the time interval and fits a statistical model to the interactions based on times within the time interval when various interactions occurred. The online system may use any suitable method of statistical analysis to determine the model based on the obtained information and the time interval corresponding to interactions described by the obtained information. In various embodiments, the model determined by the online system is a survival model, such as a Weibull distribution or log-normal distribution, for which the online system determines parameters from the obtained information. Analyzing the interactions described by the obtained information allows the online system to determine a rate at which the survival model decreases through the time interval and through additional time interval, from which the online system determines the model. Hence, the model allows the online system to determine percentages, or numbers, of online system users likely to interact with the target object at different items within the additional time interval. The online system may account for interactions by users of the set with objects having at least a threshold amount of characteristics matching characteristics of the target object when determining the model.

To allow the publishing user to more particularly evaluate interactions by online system users with an object, the online system identifies a specific duration within the additional time interval. In various embodiments, the online system receives the specific duration from the publishing user. For example, the publishing user identifies the specific duration by specifying a starting time of the specific duration within the additional time interval and an ending time of the specific duration within the additional time interval. As another example, the publishing user provides a starting time within the additional time interval and a length of time to identify the specific duration to the online system. Alternatively, the online system identifies the specific duration based on historical interactions with objects by users of the set and the determined model. For example, the online system identifies the specific duration as a length of time within the additional time interval where a percentage of users, or a number of users, likely to interact with an object equals or exceeds a threshold.

Based on the model, the online system determines an average amount of time online system users are predicted to interact with the target object during the specific duration. For example, the model identifies a percentage of users estimated to interact with the target object, and the online system determines an integral of the model from a starting time of the specific duration to an ending time of the specific duration to determine an average amount of time a user interacts with the target object during the specific duration. In various embodiments, the model determines a percentage of users estimated to interact with the target object per day within the additional time interval, so the online system determines an average number of days a user interacts with the target object during the specific duration.

The online system also retrieves amounts of revenue received from users during the time interval and determines an average amount of revenue per unit of time during the time interval. In some embodiments, the retrieved amounts of revenue are amounts of revenue received by a publishing user associated with the one or more objects during the time interval, while in other embodiments, the retrieved amounts of revenue are amounts of revenue received by the online system during the time interval. For example, the online system retrieves amounts of revenue received from users during the time interval and determines an average amount of revenue received per day by dividing the amount of revenue received from users during the time interval by a number of days in the time interval. In various embodiments, the online system identifies unique users who performed a particular action one or more times during the time interval and retrieves amounts of revenue received during the time interval from the identified unique users. Based on the amounts of revenue received from the identified unique users during the time interval, the online system determines the average amount of revenue per unit of time during the time interval. For example, the online system identifies unique users who accessed a particular object at least once during the time interval, retrieves amounts of revenue the online system received from the identified users during the time interval, and divides a total amount of revenue received from the identified users during the time interval by a number of days in the time interval to determine an average amount of revenue received per day from unique users who accessed the particular object.

Based on the average amount of revenue per unit of time and the average amount of time online system users are predicted to interact with the target object during the specific duration, the online system determines a value of presenting a target item associated with the target object to online system users. In various embodiments, the online system determines the value as a product of the average amount of revenue per unit of time and the average amount of time online system users are predicted to interact with the target object during the specific duration. For example the unit of time is a day, so the online system determines the value as a product of the average amount of revenue per day and the average number of days online system users are predicted to interact with the target object during the specific duration.

The online system communicates the determined value to a client device for presentation to the publishing user, allowing the publishing user to evaluate estimated revenue from interaction with the target object by online system users during the specific interval. In various embodiments, the publishing user determines bid amounts for content items associated with the target object based on the determined value, allowing the publishing user to account for estimated revenue when determining compensation to the online system for resenting content items identifying, or otherwise associated with, the target object. For example, the publishing user provides the online system with a content item associated with the target object including a bid amount that is a percentage of the determined value.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for determining value to a publishing user of presenting a content item to online system users during a specific duration, in accordance with an embodiment.

FIG. 4 is an example of information presented to a publishing user identifying different budgets and corresponding estimated numbers of actions for presenting a content item, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

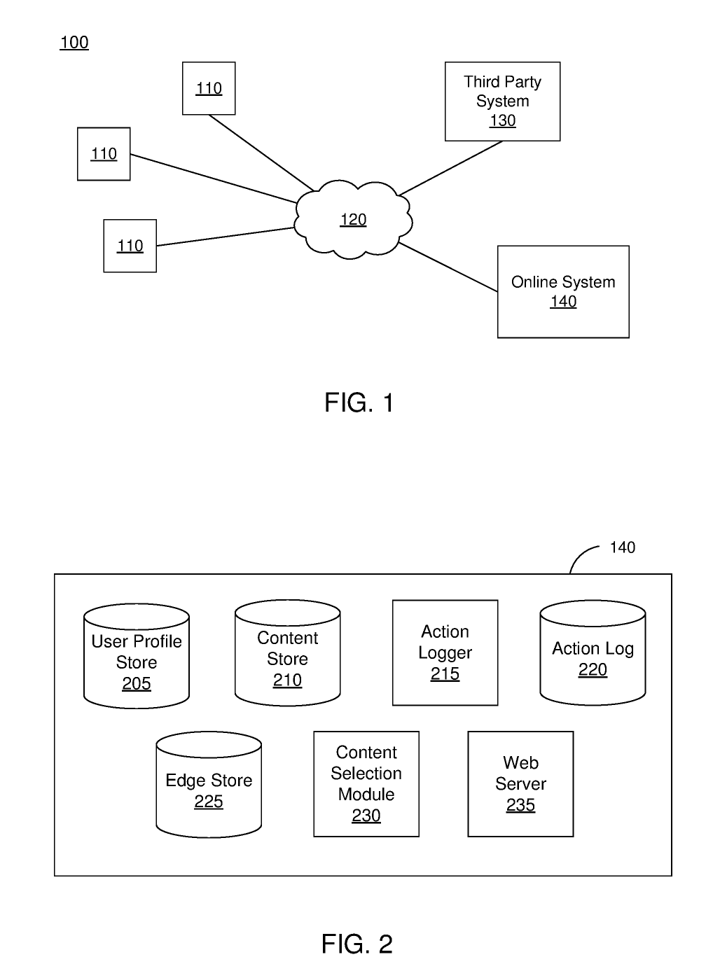

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 140 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third party applications or third party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. Content presented to a user may be text, image, audio, video, or any other suitable data. In various embodiments, the content also specifies a page of content. For example, a content item includes a landing page specifying a network address of a page of content to which a user is directed when the content item is accessed. The bid amount is included in a content item by a publishing user and is used to determine an expected value, such as monetary compensation, provided by the publishing user to the online system 140 if content in the content item is presented to a user, if the content in the content item receives particular interaction from a user when presented, or if any suitable condition is satisfied when content in the content item is presented to a user. For example, the bid amount included in a content item specifies a monetary amount that the online system 140 receives from the publishing user if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that the publishing user providing the content item to the online system 140 desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from the publishing user associated with content item as online system users perform interactions with a content item that satisfy the objective included in the content item.

In various embodiments, the online system 140 receives a budget for presenting the content item from the publishing user. The budget specifies a maximum amount of compensation the publishing user provides the online system 140 during a specific time interval for presenting the content item to other users. When presenting the content item to users, the online system 140 presents the content item until the online system 140 receives an amount of compensation from the publishing user equaling the budget. After receiving an amount of compensation form the publishing user equaling the budget, the online system 140 withholds presentation of the content item to other users during the specific time interval specified by the budget.

Additionally, a content item may include one or more targeting criteria specified by the publishing user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow the publishing user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions (or “interactions”) on the online system 140, as well as actions (or “interactions”) on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements or other content with which the user engaged, purchases made, and other patterns from shopping and buying. Hence, the action log 220 may include information identifying content provided by one or more third party systems 130 that a user of the online system 140 has accessed or content provided by one or more third party systems 130 with which the user of the online system 140 otherwise interacted. Various third party systems 130 may include tracking mechanisms in content comprising instructions that, when executed by a client device 110, provide information identifying the content and identifying a user of the online system 140 associated with the client device 110 to the online system 140. In various embodiments, the information provided by the tracking mechanism identifies one or more products associated with a third party system 130 and include in, or otherwise associated with, the identified content. The information identifying the content is stored in the action log 220 in association with information identifying the user to the online system 140. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items that are not associated with bid amounts, such as stories describing actions associated with other online system users connected to the user. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

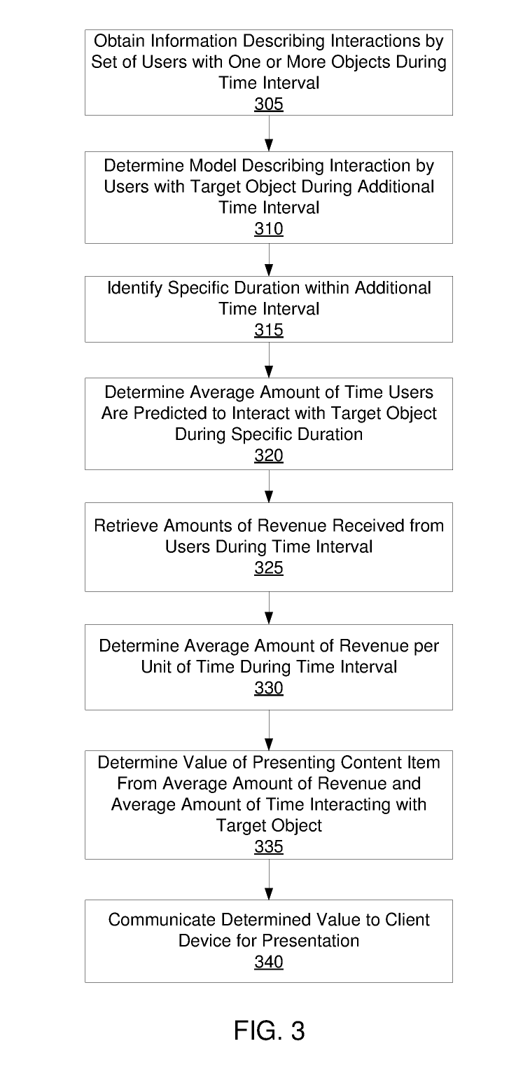

In various embodiments, the content selection module 230 determines a value to a publishing user for presenting one or more content items associated with a target object to users via the online system 140. The target object may be an application, a web page, a page, a content item, or any other information or content associated with the publishing user. To allow the publishing user to account for a value of the publishing user of presenting content items associated with a target object, the content selection module 230 obtains information describing interactions by a set of users during a time interval with one or more objects. As further described below in conjunction with FIG. 3, the content selection module 230 identifies users who performed an interaction with one or more objects having at least a threshold amount of characteristics matching characteristics of the target object within the time interval. Alternatively, the content selection module 230 identifies users who performed an interaction with the target object within the time interval. Based on the retrieved information, the content selection module 230 determines a model describing user interaction with one or more objects during an additional time interval that is longer than the time interval. As further described below in conjunction with FIG. 3, the content selection module 230 determines parameters for a survival model based on the obtained interactions and the time interval.

In addition to the model, the content selection module 230 also retrieves amounts of compensation received from users during the time interval. From the retrieved amounts of compensation, the content selection module 230 determines an average amount of compensation per unit of time received form users. Based on the model, the content selection module 230 determines an average amount of time online system users are predicted to interact with the target object during a specific duration of the additional time interval. As further described below in conjunction with FIG. 3, the content selection module 230 determines the value to the user of presenting one or more content items associated with the target object via the online system 140 based on the average amount of time online system users are predicted to interact with the target object during the specific duration and the average amount of compensation per unit of time. The content selection module 230 provides the determined value to the publishing user, who may account for the determined value when allocating resources for presenting content items associated with the target object via the online system 140.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

### Determining Values to a Publishing User of Presenting a Content Item for a Duration

FIG. 3 is a flowchart of one embodiment of a method for determining value to a publishing user of presenting a content item to online system users during a specific duration. In other embodiments, the method may include different and/or additional steps than those shown in FIG. 3. Additionally, steps of the method may be performed in different orders than the order described in conjunction with FIG. 3 in various embodiments.

A publishing user provides one or more content items to an online system 140 to distribute information about objects, such as products or services, associated with the publishing user to online system users. Content items presented to users by the online system 140 may encourage users to perform various interactions with objects associated with the publishing user, which may provide revenue or other benefits to the publishing user. For example, the publishing user provides content items to the online system 140 associated with an application associated with the publishing user to encourage other online system users to install the application or to purchase items for use via the application. This allows the publishing user to leverage information maintained by the online system 140 to disseminate information about one or more objects associated with the publishing user to a broader audience.

Often the publishing user compensates the online system 140 for presenting the one or more content items. For example, the online system 140 receives compensation from the publishing user for each presentation of a content item from the publishing user to an online system user. As another example, the online system 140 receives compensation from the publishing user each time an online system user to whom a content item from the publishing user was presented by the online system 140 performs a specific action (e.g., selects a link included in the content item). The publishing user may include a bid amount in each content item that specifies a maximum amount of compensation the publishing user provides the online system 140 when a content item is presented by the online system 140 or when an online system user presented with the content item performed a particular action. Accounting for revenue the publishing user receives from online system users to whom one or more content items from the publishing user were presented by the online system 140 allows the publishing user to more effectively specify bid amounts for various content items provided to the online system 140. However, the publishing user has limited information regarding actions by online system users to whom content items were presented outside of a relatively short time interval after presentation of a content item, limiting accuracy with which the publishing user may specify bid amounts for content items.

To allow the publishing user to better estimate revenue from online system users over longer time intervals, the online system 140 obtains 305 information describing interaction by each of a set of users of the online system 140 during a time interval with one or more objects for which the online system 140 maintains information. In some embodiments, each user of the set has one or more specific characteristics. For example, each user of the set is a user to whom a content item provided to the online system 140 by the publishing user was presented within a particular time interval. The content item in the preceding example may be a content item having one or more specific characteristics. For example, the content item is associated with a specific type of object or is associated with a user having one or more specific characteristics, one or more of which may be specified by the publishing user. The obtained information may identify specific actions performed by each user of the set during the time interval; in some embodiments, the publishing user may identify the specific actions. For example, the obtained information identifies one or more interactions by users with an application having one or more characteristics. Alternatively, the obtained information identifies each action performed by users of the set during the time interval

In some embodiments, the online system 140 obtains 305 the information describing interactions by the set of users with the one or more objects during the time interval from the publishing user. For example, the publishing user maintains information describing interactions by users with an application or with other content provided by the publishing user during the time interval and provides the information to the online system 140. Alternatively, the online system 140 identifies users who interacted with one or more objects during the time interval based on information stored by the online system 140 identifying actions performed by users. For each of the identified users, the online system 140 obtains interactions by the identified users with one or more objects during the time interval. In some embodiments, the publishing user identifies a target object to the online system 140, so the online system 140 identifies users who performed an action associated with the target object, or with objects having at least a threshold amount of characteristics matching characteristics of the target object, during the time interval.

From the obtained information describing interaction by each of the set of users with the one or more objects during the time interval, the online system 140 determines 310 a model describing interaction by online system users with the target object during an additional time interval, which is longer than the time interval for which the information was obtained 305. In various embodiments, the online system 140 analyzes interactions by users with the one or more objects at different times within the time interval and fits a statistical model to the interactions based on times within the time interval when various interactions occurred. The online system 140 may use any suitable method of statistical analysis to determine 310 the model based on the obtained information and the time interval corresponding to interactions described by the obtained information. In various embodiments, the model determined 310 by the online system 140 is a survival model, such as a Weibull distribution or log-normal distribution, for which the online system 140 determines parameters from the obtained information. A survival model used by the online system 140 identifies a percentage of users performing one or more interactions with target object at different times and has 100% of users performing one or more interactions with the one or more objects at a time prior to a start of the time interval, and the percentage of users performing the one or more interactions decreases throughout the time interval. Analyzing the interactions described by the obtained information allows the online system 140 to determine a rate at which the survival model decreases through the time interval and through additional time interval, from which the online system 140 determines 310 the model. Hence, the model allows the online system 140 to determine percentages, or numbers, of online system users likely to interact with the target object at different items within the additional time interval. The online system may account for interactions by users of the set with objects having at least a threshold amount of characteristics matching characteristics of the target object when determining 310 the model.

To allow the publishing user to more particularly evaluate interactions by online system users with an object, the online system 140 identifies 315 a specific duration within the additional time interval. In various embodiments, the online system 140 receives the specific duration from the publishing user. For example, the publishing user identifies the specific duration by specifying a starting time of the specific duration within the additional time interval and an ending time of the specific duration within the additional time interval. As another example, the publishing user provides a starting time within the additional time interval and a length of time to identify 315 the specific duration to the online system 140. Alternatively, the online system 140 identifies 315 the specific duration based on historical interactions with objects by users of the set and the determined model. For example, the online system 140 identifies 315 the specific duration as a length of time within the additional time interval where a percentage of users, or a number of users, likely to interact with an object equals or exceeds a threshold. As another example, the online system 140 identifies 315 the specific duration as a length of time within the additional time interval where a percentage of users, or a number of users, likely to interact with an object equals or exceeds a minimum value and is less than or equal to a maximum value. In the preceding examples, the threshold, the maximum value, or the minimum value may be specified by the publishing user. Alternatively, the online system 140 determines one or more of the threshold, the minimum value, or the maximum value based on characteristics of the publishing user and characteristics of one or more additional publishing users associated with objects with which users of the set interacted; for example, the online system 140 determines the threshold, the maximum value, or the minimum value based on prior interactions by users of the set with objects associated with additional publishing users having at least a threshold amount of characteristics matching characteristics of the publishing user.

Based on the model, the online system 140 determines 320 an average amount of time online system users are predicted to interact with the target object during the specific duration. For example, the model identifies a percentage of users estimated to interact with the target object, and the online system 140 determines an integral of the model from a starting time of the specific duration to an ending time of the specific duration to determine 320 an average amount of time a user interacts with the target object during the specific duration. In various embodiments, the model determines a percentage of users estimated to interact with the target object per day within the additional time interval, so the online system 140 determines an average number of days a user interacts with the target object during the specific duration. Alternatively, the model determines a percentage (or a number) of users estimated to interact with the target object during any suitable unit of time (e.g., hours, months, weeks, etc.).

The online system 140 also retrieves 325 amounts of revenue received from users during the time interval and determines 330 an average amount of revenue per unit of time during the time interval. In some embodiments, the retrieved amounts of revenue are amounts of revenue received by a publishing user associated with the one or more objects during the time interval, while in other embodiments, the retrieved amounts of revenue are amounts of revenue received by the online system 140 during the time interval. For example, the online system 140 retrieves 325 amounts of revenue received from users during the time interval and determines 330 an average amount of revenue received per day by dividing the amount of revenue received from users during the time interval by a number of days in the time interval. In various embodiments, the online system 140 identifies unique users who performed a particular action one or more times during the time interval and retrieves 325 amounts of revenue received during the time interval from the identified unique users. Based on the amounts of revenue received from the identified unique users during the time interval, the online system 140 determines 330 the average amount of revenue per unit of time during the time interval. For example, the online system 140 identifies unique users who accessed a particular object at least once during the time interval, retrieves 325 amounts of revenue the online system 140 received from the identified users during the time interval, and divides a total amount of revenue received from the identified users during the time interval by a number of days in the time interval to determine 330 an average amount of revenue received per day from unique users who accessed the particular object.

Based on the average amount of revenue per unit of time and the average amount of time online system users are predicted to interact with the target object during the specific duration, the online system 140 determines 335 a value of presenting a target item associated with the target object to online system users. In various embodiments, the online system 140 determines 335 the value as a product of the average amount of revenue per unit of time and the average amount of time online system users are predicted to interact with the target object during the specific duration. For example the unit of time is a day, so the online system 140 determines 335 the value as a product of the average amount of revenue per day and the average number of days online system users are predicted to interact with the target object during the specific duration. Hence, the value determined by the online system 140 specifies an estimated amount of compensation for the publishing user during the specific duration from user interaction with the target object.

The online system 140 communicates 340 the determined value to a client device 110 for presentation to the publishing user, allowing the publishing user to evaluate estimated revenue from interaction with the target object by online system users during the specific interval. In various embodiments, the publishing user determines bid amounts for content items associated with the target object based on the determined value, allowing the publishing user to account for estimated revenue when determining compensation to the online system 140 for resenting content items identifying, or otherwise associated with, the target object. For example, the publishing user provides the online system 140 with a content item associated with the target object including a bid amount that is a percentage of the determined value. As another example, the publishing user provides multiple content items associated with the target object to the online system 140 along with a budget for presenting the multiple content items during the specific duration that equals the determined value, or equaling a percentage of the determined value, and instructions for the online system 140 to determine a bid amount for presenting each of the content items subject to the budget.

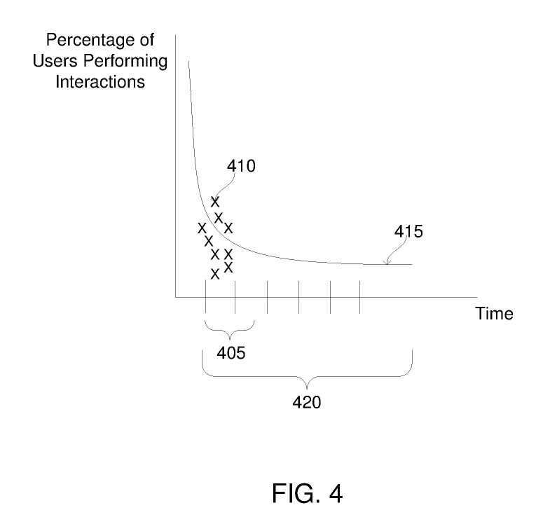

FIG. 4 shows an example of an online system 140 modeling user interaction with an object. In the example of FIG. 4, the online system 140 obtains information for a time interval 405 identifying user interactions 410 with one or more objects during the time interval 405. For purposes of illustration, FIG. 4 shows the obtained information as percentages of online system users who performed one or more interactions 410 with one or more objects. In various embodiments, the obtained information identifies percentages of users who performed one or more particular interactions 410 with an object (e.g., an application) at different times within the time interval 405. As further described above in conjunction with FIG. 3, based on the interactions 410 within the time interval 405 the online system 140 determines a model 415 describing interaction by online system users with a target object specified by a publishing user (e.g., an application) during an additional time interval 420 that is longer than the time interval 405. The online system 140 identifies a specific duration within the additional time interval 420, and determines an average amount of time online system users are predicted to interact with the target object during the specific duration. In the example of FIG. 4, the online system determines the average amount of time by determining an area under the model 420 during the specific duration. As further described above in conjunction with FIG. 3, the online system 140 retrieves amounts of revenue received form users during the time interval 405 and determines an average amount of revenue received per unit of time that is used along with the average amount of time interacting with the target object to determine a value to the publishing user of presenting content items associated with the target object during the specific duration.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
obtaining, at an online system, information describing interaction with one or more objects by each of a set of users of the online system during a time interval, the online system maintaining information associated with each of the one or more objects;
determining a model describing interaction by users of the online system with a target object during an additional time interval based on the interactions by each of the set of users described by the obtained information, the additional time interval longer than the time interval;
identifying a specific duration within the additional time interval;
determining an average amount of time online system users are predicted to interact with the target object during the specific duration from the determined model;
retrieving amounts of revenue received from users of the online system during the time interval;
determining an average amount of revenue received per unit of time based on the retrieved amounts of revenue and the time interval;
determining a value of presenting a content item associated with the target object to users of the online system based on the average amount of revenue per unit of time and the average amount of time online system users are predicted to interact with the target object during the specific duration; and
communicating the determined value to a client device for presentation to a publishing user associated with the target object.

2. The method of claim 1, further comprising:
receiving a content item associated with the target object from the publishing user, the content item having a bid amount specifying an amount of compensation the publishing user provides the online system in exchange for presenting the content item that is based on the determined value.

3. The method of claim 1, wherein obtaining, at the online system, information describing interaction with one or more objects by each of the set of users of the online system during the time interval comprises:
receiving information from the publishing user describing interaction by the set of users with one or more objects associated with the publishing user during the time interval.

4. The method of claim 1, wherein obtaining, at the online system, information describing interaction with one or more objects by each of the set of users of the online system during the time interval comprises:
identifying users who interacted with one or more objects having at least a threshold amount of characteristics matching characteristics of the target object during the time interval; and
retrieving information maintained by the online system describing interactions by the identified users with the one or more objects having at least a threshold amount of characteristics matching characteristics of the target object during the time interval.

5. The method of claim 1, wherein determining a model describing interaction by users of the online system with the target object during the additional time interval based on the interactions by each of the set of users described by the obtained information comprises:
determining a Weibull distribution based on the interactions by each of the set of users described by the obtained information and the time interval.

6. The method of claim 1, wherein determining a model describing interaction by users of the online system with the target object during the additional time interval based on the interactions by each of the set of users described by the obtained information comprises:
determining a log-normal distribution based on the interactions by each of the set of users described by the obtained information and the time interval.

7. The method of claim 1, wherein determining the average amount of time online system users are predicted to interact with the target object during the specific duration from the determined model comprises:
determining an average number of days online system users are predicted to interact with the target object during the specific duration using the determined model.

8. The method of claim 7, wherein determining the average amount of revenue received per unit of time based on the retrieved amounts of revenue and the time interval comprises:
determining an average amount of revenue received per day from amounts of revenue received from users of the online system based on the retrieved amounts of revenue and the time interval.

9. The method of claim 8, wherein determining the value of presenting the content item associated with the target object to users of the online system based on the average amount of revenue per unit of time and the average amount of time online system users are predicted to interact with the target object during the specific duration comprises:
determining a product of the average amount of revenue per unit time received per day and the average number of days online system users are predicted to interact with the target object during the specific duration.

10. The method of claim 1, wherein determining the value of presenting the content item associated with the target object to users of the online system based on the average amount of revenue per unit time and the average amount of time online system users are predicted to interact with the target object during the specific duration comprises:
determining a product of the average amount of time online system users are predicted to interact with the target object during the specific duration and the average amount of revenue.

11. A computer program product comprising a computer readable storage medium having instructions encoded thereon that, when executed by a processor, cause the processor to:
obtain, at an online system, information describing interaction with one or more objects by each of a set of users of the online system during a time interval, the online system maintaining information associated with each of the one or more objects;
determine a model describing interaction by users of the online system with a target object during an additional time interval based on the interactions by each of the set of users described by the obtained information, the additional time interval longer than the time interval;
identify a specific duration within the additional time interval;
determine an average amount of time online system users are predicted to interact with the target object during the specific duration from the determined model;
retrieve amounts of revenue received from users of the online system during the time interval;
determine an average amount of revenue received per unit of time based on the retrieved amounts of revenue and the time interval;
determine a value of presenting a content item associated with the target object to users of the online system based on the average amount of revenue per unit of time and the average amount of time online system users are predicted to interact with the target object during the specific duration; and
communicate the determined value to a client device for presentation to a publishing user associated with the target object.

12. The computer program product of claim 11, wherein the computer readable storage medium further has instructions encoded thereon that, when executed by the processor, cause the processor to:
receive a content item associated with the target object from the publishing user, the content item having a bid amount specifying an amount of compensation the publishing user provides the online system in exchange for presenting the content item that is based on the determined value.

13. The computer program product of claim 11, wherein obtain, at the online system, information describing interaction with one or more objects by each of the set of users of the online system during the time interval comprises:
receive information from the publishing user describing interaction by the set of users with one or more objects associated with the publishing user during the time interval.

14. The computer program product of claim 11, wherein obtain, at the online system, information describing interaction with one or more objects by each of the set of users of the online system during the time interval comprises:
identify users who interacted with one or more objects having at least a threshold amount of characteristics matching characteristics of the target object during the time interval; and
retrieve information maintained by the online system describing interactions by the identified users with the one or more objects having at least a threshold amount of characteristics matching characteristics of the target object during the time interval.

15. The computer program product of claim 11, wherein determine a model describing interaction by users of the online system with the target object during the additional time interval based on the interactions by each of the set of users described by the obtained information comprises:
determine a Weibull distribution based on the interactions by each of the set of users described by the obtained information and the time interval.

16. The computer program product of claim 11, wherein determine a model describing interaction by users of the online system with the target object during the additional time interval based on the interactions by each of the set of users described by the obtained information comprises:
determine a log-normal distribution based on the interactions by each of the set of users described by the obtained information and the time interval.

17. The computer program product of claim 11, wherein determine the average amount of time online system users are predicted to interact with the target object during the specific duration from the determined model comprises:
determine an average number of days online system users are predicted to interact with the target object during the specific duration using the determined model.

18. The computer program product of claim 17, wherein determine the average amount of revenue received per unit of time based on the retrieved amounts of revenue and the time interval comprises:
determine an average amount of revenue received per day from amounts of revenue received from users of the online system based on the retrieved amounts of revenue and the time interval.

19. The computer program product of claim 18, wherein determine the value of presenting the content item associated with the target object to users of the online system based on the average amount of revenue per unit of time and the average amount of time online system users are predicted to interact with the target object during the specific duration comprises:
determine a product of the average amount of revenue per unit time received per day and the average number of days online system users are predicted to interact with the target object during the specific duration.

20. The computer program product of claim 11, wherein determine the value of presenting the content item associated with the target object to users of the online system based on the average amount of revenue per unit time and the average amount of time online system users are predicted to interact with the target object during the specific duration comprises:
determine a product of the average amount of time online system users are predicted to interact with the target object during the specific duration and the average amount of revenue.
